(19) United States
(12) Patent Application Publication
(10) Pub. No.: US 2026/0254730 A1
(43) Pub. Date: Aug. 27, 2026

(54) MODEL FUNCTIONALITY MONITORING

(71) Applicant: Nokia Technologies Oy, Espoo (FI)

(72) Inventors: Keeth Saliya Jayasinghe LADDU, Espoo (FI); Amaanat ALI, Espoo (FI); Dimitri GOLD, Espoo (FI); Mihai ENESCU, Espoo (FI); Sakira HASSAN, Espoo (FI); Endrit DOSTI, Espoo (FI)

(21) Appl. No.: 19/159,925

(22) PCT Filed: Jan. 29, 2024
(86) PCT No.: PCT/EP2024/052071

§ 371 Date: Aug. 26, 2025

(30) Foreign Application Priority Data
Mar. 28, 2023 (FI) 20235354

(51) Int. Cl. H04L 41/16; H04L 41/5009

(52) U.S. Cl. CPC H04L 41/16; H04L 41/5009

(57) ABSTRACT

Embodiments of the present disclosure relate to model functionality monitoring. A terminal device receives, from a network device, first information for configuring at least one time window for monitoring a performance of an AI/ML model functionality. The terminal device receives second information indicative of a first time window during which the performance of the AI/ML model functionality is above a performance level, or of a second time window during which the performance of the AI/ML model functionality is below the performance level. The terminal device performs, based on the second information, a management operation associated with a plurality of AI/ML models configured to carry out the AI/ML model functionality. The solution for model functionality monitoring as provided in the present disclosure can allow the network device to maintain reliable operation without knowing exactly which model the terminal device is using.

### FIELD

Various example embodiments generally relate to the field of communication, and in particular, to a terminal device, a network device, methods, apparatuses and a computer readable storage medium for model functionality monitoring.

### BACKGROUND

With the development of communication technology, model based new radio (NR) air interfaces and resource allocation schemes have been studied. For example, in a third generation partnership project (3GPP) Release 18 (Rel-18) study item (SI), a goal is to explore the benefits of augmenting the air interface with features enabling improved support of AI/ML-based algorithms for enhanced performance and/or reduced complexity/overhead.

As an example, in RAN #111, in order to distinguish AI/ML models and functionalities supported by the AI/ML models, two different AI/ML-related identification types (functionality identification and model-identification) are introduced. The model identification is assumed to use a “model-ID” in the identification process and the functionality identification is assumed to use a “functionality-ID” (with or without explicit model ID) in the identification process.

### SUMMARY

In general, example embodiments of the present disclosure provide a terminal device, a network device, methods, apparatuses and a computer readable storage medium for AI/ML model functionality monitoring. For example, the solution provided by the example embodiments of the present disclosure can allow the network device to maintain reliable AI/ML operation without knowing exactly which AI/ML model the terminal device is using.

In a first aspect, there is provided a terminal device. The terminal device may comprise at least one processor; and at least one memory storing instructions that, when executed by the at least one processor, cause the terminal device at least to receive, from a network device, first information for configuring at least one time window for monitoring a performance of an AI/ML model functionality; receive, from the network device, second information indicative of a first time window among the at least one time window during which the performance of the AI/ML model functionality is above a performance level, or of a second time window among the at least one time window during which the performance of the AI/ML model functionality is below the performance level; and perform, based on the second information, a management operation associated with a plurality of AI/ML models configured to carry out the AI/ML model functionality.

In a second aspect, there is provided a network device. The network device may comprise at least one processor; and at least one memory storing instructions that, when executed by the at least one processor, cause the network device at least to: transmit, to a terminal device, first information for configuring at least one time window for monitoring a performance of an AI/ML model functionality; determine a first time window among the at least one time window during which the performance of the AI/ML model functionality is above a performance level, or a second time window among the at least one time window during which the performance of the AI/ML model functionality is below the performance level; and transmit, to the terminal device, second information indicative of the first time window or of the second time window.

In a third aspect, there is provided a method. The method may comprise: receiving, at a terminal device and from a network device, first information for configuring at least one time window for monitoring a performance of an AI/ML model functionality; receiving, at the terminal device and from the network device, second information indicative of a first time window among the at least one time window during which the performance of the AI/ML model functionality is above a performance level, or of a second time window among the at least one time window during which the performance of the AI/ML model functionality is below the performance level; and performing, at the terminal device and based on the second information, a management operation associated with a plurality of AI/ML models configured to carry out the AI/ML model functionality.

In a fourth aspect, there is provided a method. The method may comprise: transmitting, at a network device and to a terminal device, first information for configuring at least one time window for monitoring a performance of an AI/ML model functionality; determining, at the network device, a first time window among the at least one time window during which the performance of the AI/ML model functionality is above a performance level, or a second time window among the at least one time window during which the performance of the AI/ML model functionality is below the performance level; and transmitting, at the network device and to the terminal device, second information indicative of at least one of the first time window or of the second time window.

In a fifth aspect, there is provided an apparatus of a terminal device. The apparatus may comprise: means for receiving, from a network device, first information for configuring at least one time window for monitoring a performance of an AI/ML model functionality; means for receiving, from the network device, second information indicative of a first time window among the at least one time window during which the performance of the AI/ML model functionality is above a performance level, or of a second time window among the at least one time window during which the performance of the AI/ML model functionality is below the performance level; and means for performing, based on the second information, a management operation associated with a plurality of AI/ML models configured to carry out the AI/ML model functionality.

In a sixth aspect, there is provided an apparatus of a network device. The apparatus may comprise: means for transmitting, to a terminal device, first information for configuring at least one time window for monitoring a performance of an AI/ML model functionality; means for determining, at the network device, a first time window among the at least one time window during which the performance of the AI/ML model functionality is above a performance level, or a second time window among the at least one time window during which the performance of the AI/ML model functionality is below the performance level; and means for transmitting, to the terminal device, second information indicative of at least one of the first time window or of the second time window.

In a seventh aspect, there is provided a non-transitory computer readable medium comprising program instructions for causing an apparatus to perform at least the method according to the third or fourth aspect.

In an eighth aspect, there is provided a computer program comprising instructions, which, when executed by an apparatus, cause the apparatus at least to: receive, from a network device, first information for configuring at least one time window for monitoring a performance of an AI/ML model functionality; receive, from the network device, second information indicative of a first time window among the at least one time window during which the performance of the AI/ML model functionality is above a performance level, or of a second time window among the at least one time window during which the performance of the AI/ML model functionality is below the performance level; and perform, based on the second information, a management operation associated with a plurality of AI/ML models configured to carry out the AI/ML model functionality.

In a ninth aspect, there is provided a computer program comprising instructions, which, when executed by an apparatus, cause the apparatus at least to: transmit, to a terminal device, first information for configuring at least one time window for monitoring a performance of an AI/ML model functionality; determine a first time window among the at least one time window during which the performance of the AI/ML model functionality is above a performance level, or a second time window among the at least one time window during which the performance of the AI/ML model functionality is below the performance level; and transmit, to the terminal device, second information indicative of the first time window or of the second time window.

In a tenth aspect, there is provided a terminal device. The terminal device may comprise a first receiving circuitry configured to receive, from a network device, first information for configuring at least one time window for monitoring a performance of an AI/ML model functionality; a second receiving circuitry configured to receive, from the network device, second information indicative of a first time window among the at least one time window during which the performance of the AI/ML model functionality is above a performance level, or of a second time window among the at least one time window during which the performance of the AI/ML model functionality is below the performance level; and a performing circuitry configured to perform, based on the second information, a management operation associated with a plurality of AI/ML models configured to carry out the AI/ML model functionality.

In an eleventh aspect, there is provided a network device. The network device may comprise a first transmitting circuitry configured to transmit, to a terminal device, first information for configuring at least one time window for monitoring a performance of an AI/ML model functionality; a determining circuitry configured to determine a first time window among the at least one time window during which the performance of the AI/ML model functionality is above a performance level, or a second time window among the at least one time window during which the performance of the AI/ML model functionality is below the performance level; a second transmitting circuitry configured to transmit, to the terminal device, second information indicative of the first time window or of the second time window.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example network environment in which example embodiments of the present disclosure may be implemented;

FIG. 1B illustrates an example illustration of AI/ML model functionality monitoring related to some embodiments of the present disclosure;

FIG. 2 illustrates an example signaling process for AI/ML model functionality monitoring according to some embodiments of the present disclosure;

FIG. 3 illustrates another example signaling process for AI/ML model functionality monitoring according to some embodiments of the present disclosure;

FIG. 4 illustrates an example flowchart of a method implemented at a terminal device in accordance with some example embodiments of the present disclosure;

FIG. 5 illustrates an example flowchart of a method implemented at a network device in accordance with some example embodiments of the present disclosure;

FIG. 6 illustrates an example simplified block diagram of a device that is suitable for implementing embodiments of the present disclosure; and

FIG. 7 illustrates an example block diagram of an example computer readable medium in accordance with some embodiments of the present disclosure;

Throughout the drawings, the same or similar reference numerals represent the same or similar element.

### DETAILED DESCRIPTION

Principle of the present disclosure will now be described with reference to some example embodiments. It is to be understood that these embodiments are described for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band Internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial, a relay node, an integrated access and backhaul (IAB) node, and/or industrial wireless networks, and the like. In the following description, the terms “terminal device”, “communication device”, “terminal”, “user equipment” and “UE” may be used interchangeably.

As used herein, the term “resource”, “transmission resource”, “resource block”, “physical resource block” (PRB), “uplink (UL) resource” or “downlink (DL) resource” may refer to any resource for performing a communication, for example, a communication between a terminal device and a network device, such as a resource in time domain, a resource in frequency domain, a resource in space domain, a resource in code domain, a resource in a combination of more than one domain or any other resource enabling a communication, and the like. In the following, a resource in time domain (such as, a subframe) will be used as an example of a transmission resource for describing some example embodiments of the present disclosure. It is noted that example embodiments of the present disclosure are equally applicable to other resources in other domains.

The terms artificial intelligence and/or machine learning (AI/ML) refer to software-implemented methods based on mathematical algorithms or models providing an inference function. Such models are typically mathematical algorithms, trained with information and that replicate a decision an expert would make when provided that same information. According to some embodiments, AI/ML functions may also provide data analytics. An AI/ML training function associated e.g., with a model takes data, runs the data through the AI/ML model and derives the associated loss and adjusts the parameterization of that AI/ML model based on the computed loss. Training methods may include supervised learning, unsupervised learning and reinforcement learning, and training may be performed offline or be continuous. The inference function can be one of a number of known categories, such as regression-based, clustering- or association based, reward-based behavior, with an appropriate training method being applied.

Example applications of AI and/or ML comprise without limitation: voice recognition; image processing/computer vision; natural language processing; information retrieval; personalization and recommendation; robotics, data analytics including predictive and prescriptive analytics; use-cases for the design and/or planning and/or optimization and/or configuration and/or control and/or management of communication systems and/or networks.

Example use-cases may be without limitation:
use-cases related to the physical-layer of communication networks such as modulation, coding, decoding, signal detection, channel estimation, prediction, compression, interference mitigation;
use-cases related to the medium access control layer of communication networks such as multiple access and resource allocation (e.g., power control, scheduling, spectrum management);
channel modeling;
network optimization;
cell capacity estimation in cellular networks;
routing;
resource management;
data traffic management;
security and anomaly detection;
root cause analysis;
transport protocol design and optimization;
user/network/application behavior analysis/prediction;
transport-layer congestion control;
user experience modeling and optimization;
user mobility and positioning management;
network slicing, network virtualization and software defined networking;
non-linear impairments compensation in optical networks (e.g., visible-light communications, fiber-optics communications, and fiber-wireless converged networks), and
quality-of-transmission estimation and optical performance monitoring in optical networks.

The term AI/ML entity designates any network entity that contains one or more AI and/or ML capabilities. Example network entities comprise without limitation:
radio access network entities such as base stations (e.g., cellular base stations like eNodeB in LTE and LTE-advanced networks and gNodeB used in 5G networks, and femtocells used at homes or at business centers);
relay stations;
control stations (e.g., radio network controllers, base station controllers, network switching sub-systems);
access points in local area networks or ad-hoc networks;
gateways and radio access network entities;
network management entities (e.g., Operation, Administration and Management (OAM) entity);
network automation systems;
distributed analytics entities such as self-autonomous systems (D-SONs);
network functions (e.g., network data analytics function, NWDAF, defined in current 3GPP standards);
user equipment (UE).

As discussed above, Rel-18 3GPP started the study on AI/ML for NR air interface, and the objectives are described in RP-213599. In this study item, the goal is to explore the benefits of augmenting the air interface with features enabling improved support of AI/ML-based algorithms for enhanced performance and/or reduced complexity/overhead, several use cases are considered to enable the identification of a common AI/ML framework, including functional requirements of AI/ML architecture. The study should also identify areas where an AI/ML model could improve a performance of air-interface functions. Specification impact will be assessed to improve the overall understanding of what would be required to enable AI/ML techniques for the air interface.

For better understanding the terminologies related to AI/ML techniques, RAN1 agreements on the list of terminologies used for AI/ML are shown in Table 1.

TABLE 1

| Terminology | Description |
|---|---|
| Data collection | A process of collecting data by the network nodes, |
| | management entity, or UE for the purpose of AI/ML |
| | model training, data analytics and inference |
| AI/ML Model | A data driven algorithm that applies AI/ML techniques to |
| | generate a set of outputs based on a set of inputs. |
| AI/ML model training | A process to train an AI/ML Model [by learning the |
| | input/output relationship] in a data driven manner and |
| | obtain the trained AI/ML Model for inference |
| AI/ML model Inference | A process of using a trained AI/ML model to produce a |
| | set of outputs based on a set of inputs |
| AI/ML model validation | A subprocess of training, to evaluate the quality of an |
| | AI/ML model using a dataset different from one used for |
| | model training, that helps selecting model parameters |
| | that generalize beyond the dataset used for model |
| | training. |
| AI/ML model testing | A subprocess of training, to evaluate the performance of |
| | a final AI/ML model using a dataset different from one |
| | used for model training and validation. Differently from |
| | AI/ML model validation, testing does not assume |
| | subsequent tuning of the model. |
| UE-side (AI/ML) model | An AI/ML Model whose inference is performed entirely |
| | at the UE |
| Network-side (AI/ML) | An AI/ML Model whose inference is performed entirely |
| model | at the network |
| One-sided (AI/ML) model | A UE-side (AI/ML) model or a Network-side (AI/ML) |
| | model |
| Two-sided (AI/ML) model | A paired AI/ML Model(s) over which joint inference is |
| | performed, where joint inference comprises AI/ML |
| | Inference whose inference is performed jointly across |
| | the UE and the network, i.e., the first part of inference is |
| | firstly performed by UE and then the remaining part is |
| | performed by gNB, or vice versa. |
| AI/ML model transfer | Delivery of an AI/ML model over the air interface, either |
| | parameters of a model structure known at the receiving |
| | end or a new model with parameters. Delivery may |
| | contain a full model or a partial model. |
| Model download | Model transfer from the network to UE |
| Model upload | Model transfer from UE to the network |
| Federated learning / | A machine learning technique that trains an AI/ML |
| federated training | model across multiple decentralized edge nodes (e.g., |
| | UEs, gNBs) each performing local model training using |
| | local data samples. The technique requires multiple |
| | interactions of the model, but no exchange of local data |
| | samples. |
| Offline field data | The data collected from field and used for offline |
| | training of the AI/ML model |
| Online field data | The data collected from field and used for online training |
| | of the AI/ML model |
| Model monitoring | A procedure that monitors the inference performance of |
| | the AI/ML model |
| Supervised learning | A process of training a model from input and its |
| | corresponding labels. |
| Unsupervised learning | A process of training a model without labelled data. |
| Semi-supervised learning | A process of training a model with a mix of labelled data |
| | and unlabelled data |
| Reinforcement Learning | A process of training an AI/ML model from input (a.k.a. |
| (RL) | state) and a feedback signal (a.k.a. reward) resulting |
| | from the model's output (a.k.a. action) in an environment |
| | the model is interacting with. |
| Model activation | enable an AI/ML model for a specific function |
| Model deactivation | disable an AI/ML model for a specific function |
| Model switching | Deactivating a currently active AI/ML model and |
| | activating a different AI/ML model for a specific |
| | function |

Regarding AI/ML models and model functionalities, RAN1 #111 had the following working assumption (shown in table 2) on considered model types, considering “proprietary model” and “open-format model” as two separate model format categories for RAN1 discussion.

TABLE 2

| | |
|---|---|
| Proprietary- | ML models of vendor-/device-specific proprietary |
| format | format, from 3GPP perspective |
| models | NOTE: An example is a device-specific binary |
| | executable format |
| Open-format | ML models of specified format that are mutually |
| models | recognizable across vendors and allow interoperability, |
| | from 3GPP perspective |

It can be seen that from RAN1 discussion viewpoint, RAN1 may assume that proprietary-format models are not mutually recognizable across vendors, hide model design information from other vendors when shared. RAN1 may also assume that open-format models are mutually recognizable between vendors, and they do not hide model design information from other vendors when shared.

Enabling open-format models requires specification work to make them interoperable among devices of different vendors (e.g., by UE and network). An AI/ML model may not be separated from the rest of the function that applies the AI/ML model toward certain decision-making (inference). These may include, for example, runtime instructions, input data pre-processing, and output data post-processing algorithms. Open-format models may support cross-vendor parameter updates and over-the-air training. One example of an open format for ML models is ONNX. If 3GPP specifies a new format for ML models, it is also considered to be an open format.

In RAN1 discussions, both the “proprietary-format model” and “open-format model” are also considered as physical models or “models” in general as physical models, where physical models can be defined with a complied model for a specific hardware, a complete model for a specific hardware, a complete model with floating point parameters, or a function and complete model structure.

As discussed in background part, model identification and functionality identification are introduced to distinguish AI/ML models and functionalities supported by the AI/ML models. Tables 3 and 4 show the description of these two terms, respectively.

TABLE 3

| Terminology | Description |
|---|---|
| Model | A process/method of identifying an AI/ML model for |
| Identification | the common understanding between the NW and the UE |
| | Note: The process/method of model identification |
| | may or may not be applicable. |
| | Note: Information regarding the AI/ML model may |
| | be shared during model identification. |

TABLE 4

| Terminology | Description |
|---|---|
| Functionality | A process/method of identifying an AI/ML functionality |
| Identification | for the common understanding between the NW and the UE |
| | Note: Information regarding the AI/ML functionality |
| | may be shared during functionality identification. |
| | FFS: granularity of functionality |

The network (NW) may activate, deactivate, or switch between different functionalities (each using proprietary models at UE), based on their functionality ID. Alternatively, when available, the network may activate, deactivate, or switch between different functionalities based on the model ID combined with the associated metadata. In both alternatives, at least the functionality IDs (this may be a label to identify given functionality or use case) need to be specified in 3GPP to ensure UE-NW inter-operability without the need for bilateral agreements.

In some variants, the functionality may also be referred to as the full or partial form of a logical model, where the logical model is just an extended concept of a model or a physical model, and is mainly described by an explicit dataset, nominal inputs, nominal ideal outputs, and other parameters. Additionally, a logical model may also be described by conditions the model has to satisfy, which may also be referred to as applicable conditions (scenario, site, model usage conditions, and others). In general, a physical model can be separated from a logical model for the different handling purposes of a physical model, such as model transfer. In the following discussion, the model or model-ID may mainly refer to a physical model. However, the model or model ID can also refer as a logical model as long as the logical model is not fully identified by functionality or functionality ID.

In this way the model ID-based life cycle management (LCM) (such as model activation, model deactivation, switching, and monitoring) can be handled by UE implementation and UE vendor-specific proprietary mechanisms, while the functionality-based LCM (such as functionality activation, functionality deactivation, switching, and monitoring) is handled by the NW/NG-RAN.

The functionality ID-based LCM shall use any available Model IDs, as indicated by a UE, in the monitoring procedure, and in the potential indication to the UE about the detected performance of the functionality. This will also enable the implementation of separate LCM procedures for the functionality and the models.

In practice, model identification may not always be supported (for example, the network may not be capable of interpreting the model meta-data) and instead UE vendors may prefer to have model-ID-based LCM as UE implementation-specific matter (i.e., a UE may support more than one AI/ML model ID for a given functionality ID and decide switching across these AI/ML models without impacting the functionality). In such a case, the network may have to rely on functionality-based LCM where functionality selection, switching, deactivation, and other related LCM aspects may be carried out considering functionality IDs.

In a scenario of UE-autonomous model activation, selection, and switching for a given functionality enabled by the network, from the UE perspective, as the AI/ML models are implementation-specific, the UE may prefer to have the freedom when selecting, activating, deactivating, and switching the AI/ML models while still satisfying performance levels (e.g., defined in RAN4) for the enabled functionality.

However, from the network perspective, the performance monitoring may be carried out for the functionality ID level and any changes due to background ML model changes at the UE may not be visible at the network or controllable by the network. If the overall performance of the functionality degrades or varies significantly over time (i.e., not reliable ML model inference), due to the autonomous model selection, activation, switching, and updates at the UE side, the network may initiate the deactivation of the whole functionality (e.g., deactivation of the use of channel state information (CSI) prediction).

For example, a UE moving towards or inside a city may experience different radio channels (such as rural and urban radio channels) which need a particular adaptation of the CSI prediction process. The lack of such adaptation would result in dropped packets. Such situations should be minimized while still providing a good level of freedom to the UE to control its own AI/ML models.

Therefore, there is a need that when the model-ID-based LCM is handled by the UE (i.e., UE-sided AI/ML models and related LCM steps are not visible to the network), the network can still maintain reliable AI/ML operation for a given use case, sub-use case, ML feature, or functionality.

Example embodiments of the present disclosure provide a solution of an AI/ML model functionality monitoring. According to embodiments of the present disclosure, a terminal device receives, from a network device, first information for configuring at least one time window for monitoring a performance of an AI/ML model functionality. The terminal device receives second information indicative of a first time window during which the performance of the AI/ML model functionality is above a performance level, or of a second time window during which the performance of the AI/ML model functionality is below the performance level. The terminal device performs, based on the second information, a management operation associated with a plurality of AI/ML models configured to carry out the AI/ML model functionality. It is understood that the above procedure steps may work together, in a flow of operations as described in the next section, partly together or independently of each other.

The example embodiments for the AI/ML model functionality monitoring as provided in the present disclosure can allow the network device to maintain reliable AI/ML operation without knowing exactly which AI/ML model the terminal device is using. Principles and some example embodiments of the present disclosure will be described in detail below with reference to the accompanying drawings.

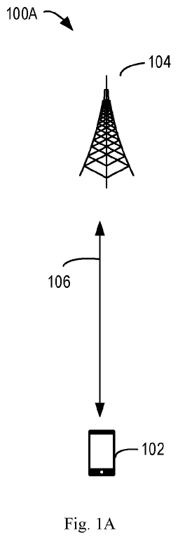

For illustrative purposes, principle and example embodiments of the present disclosure for the AI/ML model functionality monitoring will be described below with reference to FIG. 1A-FIG. 7. However, it is to be noted that these embodiments are given to enable the skilled in the art to understand inventive concepts of the present disclosure and implement the solution as proposed herein, and not intended to limit scope of the present application in any way.

Reference is made to FIG. 1A, which illustrates an example network environment 100A in which example embodiments of the present disclosure may be implemented. The network environment 100A, which may be a part of a communication network, includes a terminal device 102 and a network device 104.

As illustrated in FIG. 1A, the terminal device 102 may also be referred as a user equipment 102 or a UE 102. The network device 104 may also be referred as a gNB 104. The terminal device 102 and the network device 104 can communicate (106) with each other. The terminal device 102 may support one or more AI/ML model ID for a given functionality. For example, the one or more AI/ML model can be used for CSI prediction. The network may aware that the whole performance of CSI degrades, and determine the deactivation of the use of CSI prediction. This is because the background AI/ML model changes at the UE side may not be visible at the network or controllable by the network. For more clarity, this process will be discussed with reference to FIG. 1B.

Reference is made to FIG. 1B, which illustrates an example illustration of AI/ML model functionality monitoring related to some embodiments of the present disclosure. FIG. 1B shows an example of UE autonomous model selection, activation, and switching for a given functionality that may result in a variation in inference performance over a period of time. As illustrated in FIG. 1B, a UE 108 may correspond to the terminal device 102, which can communicate with a network device. A gNB 110 may correspond to the network device 104, which can communicate with a terminal device.

The gNB 110 may transmit (114) an AI/ML functionality enquiry (116) to the UE 108. The UE 108 may receive (112) the AI/ML functionality enquiry (116) from the gNB 110. This signaling (112, 114, 116) may be done as a UE capability enquiry. The UE 108 may transmit (118) an AI/ML functionality reporting (122) to the gNB 110. The gNB 110 may receive (120) the AI/ML functionality reporting (122) from the UE 108. This signaling (118, 120, 122) may be done as a UE capability reporting.

The gNB 110 may select or determine (124) an AI/ML functionality (assuming functionality ID X is selected herein). The gNB 110 may transmit (128) a configuration (130) of the selected functionality ID X to the UE 108. The UE 108 may receive (126) the configuration (130) from the gNB 110. The UE 108 may determine (132) any of AI/ML models (such as AI/ML models N1, N2, . . . , Nx). The UE 108 may autonomously activate or deactivate (134) the AI/ML model.

Dashed block 136 shows a detailed process of functionality performance monitoring. For example, for functionality ID X. AI/ML model N1 (corresponding to functionality ID X) may be used for inference (138). The gNB 110 may monitor (140) the functionality performance. The UE 108 may monitor (142) the performance of AI/ML model (such as AI/ML model N1). The UE 108 may autonomously switch (144) AI/ML models. For example, switching AI/ML model N1 to AI/ML model N3. The AI/ML model N3 may be used for inference (146).

The gNB 110 may monitor (148) the functionality performance. The gNB 110 may determine (150) the average performance is poor. The gNB 110 may decide to deactivate functionality ID X. The gNB 110 may transmit (154) the deactivation (156) of functionality ID X to the UE 108. The UE 108 may receive (152) the deactivation (156) of functionality ID X from the gNB 110.

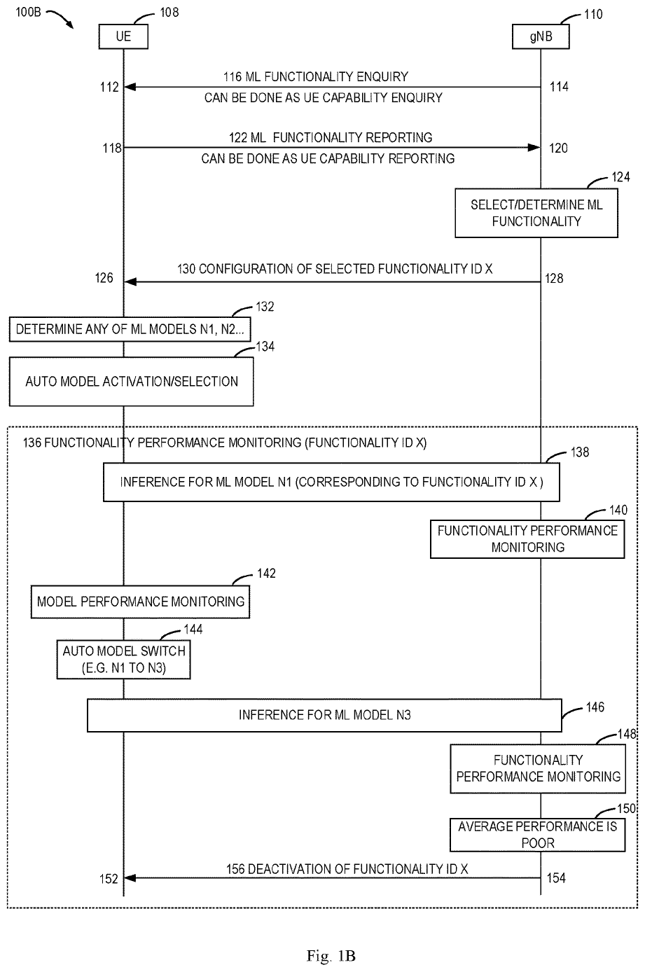

Therefore, it would be better if the network can still have control of AI/ML model if the performance is not up to the mark, other than deactivating the whole functionality. When the model-ID-based LCM is handled by the UE (i.e., UE-sided AI/ML models and related LCM steps are not visible to the network), it is necessary to allow the network to configure the UE appropriately for a given functionality ID X, and this will be discussed in FIG. 2.

Reference is made to FIG. 2, which illustrates an example signaling process 200 for AI/ML model performance monitoring according to some embodiments of the present disclosure. As shown, the network device 104 transmits (204) first information (206) to the terminal device 102. The first information is for configuring at least one time window for monitoring a performance of an AI/ML model functionality. The terminal device 102 receives (202) the first information (206) from the network device 104.

The network device 104 determines (208) a first time window among the at least one time window during which the performance of the AI/ML model functionality is above a performance level, or the network device 104 determines (208) a second time window among the at least one time window during which the performance of the AI/ML model functionality is below the performance level.

The network device 104 transmits (212) second information (214) to the terminal device 102. The second information (214) is indicative of the first time window or of the second time window. The terminal device 102 receives (210) the second information (214) from the network device 104. The terminal device 102 performs (216) a management operation associated with a plurality of AI/ML models configured to carry out the AI/ML model functionality.

In some example embodiments, the management operation may comprise activating an AI/ML model out of the plurality of AI/ML models. The management operation may further comprise deactivating an AI/ML model out of the plurality of AI/ML models. The management operation may further comprise adjusting an AI/ML model out of the plurality of AI/ML models. The management operation may further comprise switching between the plurality of AI/ML models and/or selecting between the plurality of AI/ML models.

By implementing FIG. 2, it can allow the network device to maintain reliable AI/ML operation without knowing exactly which AI/ML model the terminal device is using. That is, the network does not have to know exactly about the AI/ML model the UE is using but still have control if the performance is not good enough.

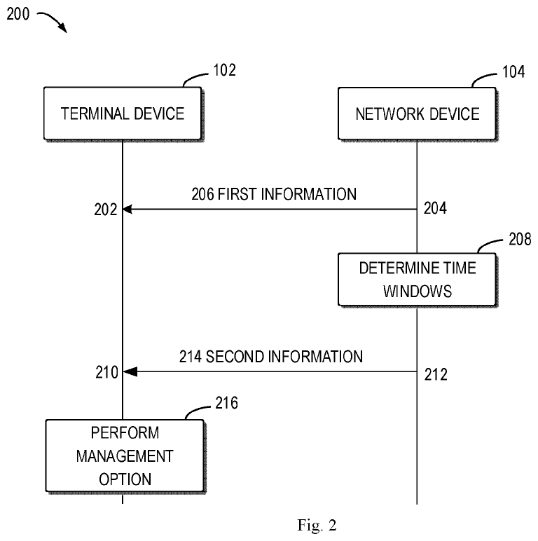

Reference is made to FIG. 3, which illustrates another example signaling process 300 for AI/ML model performance monitoring according to some embodiments of the present disclosure. It is understood that the example signaling process 300 in FIG. 3 can be considered as an example of the signaling process 200 in FIG. 2. Accordingly, the UE 302 in FIG. 3 is an example of the terminal device 102 in FIG. 2, which can communicate with a network device. The gNB 304 in FIG. 3 is an example of the network device 104 in FIG. 2, which can communicate with a terminal device. Additionally, a core network device 306 and a vendor database 308 may be engaged in some steps and signaling.

The UE 302 may be configured (310) to used AI/ML assistance for use case functionality ID X. The gNB 304 may wish (312) to determine if the UE 302 is switching different AI/ML models for the given functionality ID X. The gNB 302 at this point of time may not be sure (or not aware) if the UE 302 will be switching across multiple AI/ML model implementations (e.g., CNN and RNN, localised (cell specific) or generic ML model (applicable to multiple cells), more accurate v/s less accurate to manage better power savings) internally.

In some example embodiments, the gNB 304 may optionally take into use any tracking window data that may be stored for a given UE and a given functionality ID earlier in the core network 306. The gNB 304 may transmit (314) tracking window data request (318) for functionality ID X to the core network device 306. The core network device 306 may receive (316) tracking window data request (318) from the gNB 304. The core network device 306 may transmit (322) tracking window data response (324) for functionality ID X to the gNB 304. The gNB 302 may receive (320) tracking window data response (324) for functionality ID X from the core network device 306.

In some example embodiments, for a given model functionality (identified by an ID), the gNB 304 may use a time window, referred as the “model-LCM-tracking window” (T), that enables tracking of UE-sided model LCM-related variations. The UE-sided model LCM-related variations may include UE autonomous model activation, model selection, model deactivation, model switching, model update/fine-tuning, or other aspects.

In some example embodiments, the same aspect can be also used when instead of the network. Test equipment (TE) may be used, and UE 302 may be considered as a device under test (DUT). In this case, even though the UE 302 may not be moving, the change in of the propagation environment can be provided by channel emulation.

In some example embodiments, one or more model-LCM-tracking windows (m*T) may be considered during the inference operation of the given functionality ID. The model-LCM-tracking window durations can be different from each other (T1, T2, . . . , Tm).

The gNB 304 may generate (326) a configuration for an AI/ML model LCM by defining a tracking window configuration for UE sided AI/ML model. The gNB 304 may transmit (330) a configuration request (332) to the UE 302. The UE 302 may receive (328) the configuration request (332). The tracking window configuration may comprise aspects (1) and (2).

In some example embodiments, the aspect (1) may comprise one or more AI/ML model LCM tracking windows of a time duration T. There may be M such durations which are different across the whole time period S such that T1+T2+ . . . TM. From a UE behavior point of view, the UE 302 shall consider each epoch TM as applicable to the operation of a ML model implementation under a given functionality ID X as independent of each other.

This can allow the network to ensure that the data in each tracking window is distinct from the other without the UE having to reveal exactly which implementation it is using. For example, if the UE 302 is going to perform a handover (HO) between cell 1 and cell 2 and uses an AI/ML model to predict the reference signal received power (RSRP) in cell 1 and cell 2, it may use AI/ML model implementations as follows: in T1—cell 1 specific AI/ML model, In T2—generic AI/ML model for cell 1 and cell 2 and in T3—cell 2 specific AI/ML model.

In some example embodiments, the aspect (2) may comprise one or more events that cause the UE to perform AI/ML model switching. For example, in mobility as an AI/ML use case, the UE 302 may decide to switch AI/ML model when an execution condition for CHO (conditional handover) is reached. Another example is for an AI/ML assistance for a carrier aggregation feature when the UE 302 switches to a specific ML model (from a generic one that works for FR1 and FR2 frequencies) for e.g., to perform FR2 measurements on corresponding bands.

The UE 302 may transmit (334) a configuration response (338) to the gNB 304. The gNB 304 may receive (336) the configuration response (338) from the UE 302. Dashed block 340 shows a detailed process of functionality performance monitoring (such as for functionality ID X). The UE 302 may determine or detect (342) that the execution condition for a tracking window ID Tn is met. The UE 302 may transmit (344) an indication (348) indicating an initialization of the tracking of AI/ML model during the time window Tn. The UE 302 may receive (346) the indication (348) from the UE 302.

In some example embodiments, a tracking window ID Tn may be configured with a defined duration (in millisecond or second) that a UE will ensure to use a given AI/ML model functionality a tracking window ID with a set of execution criteria (e.g., for CHO event to allow a UE to switch between different AI/ML model functionality for source and target cell for a given functionality ID).

In this case, the UE 302 may follow the tracking window based on the set of execution criteria. For example, if the UE 302 is going to perform a HO between cell 1 and cell 2 and uses an AI/ML model to predict the RSRP in cell 1 and cell 2, it may use AI/ML models implementations as follows: In T1—cell 1 specific AI/ML model, In T2—generic AI/ML model for cell 1 and cell 2 and in T3—cell 2 specific AI/ML model. So effectively the UE 302 is counting three tracking windows but based on the execution conditions in the CHO configuration. The UE 302 may tag these as sub-tracking window IDs (e.g. Window X has sub tracking windows as X.1, X.2 and X.3 in this case).

The gNB 304 may track (350) performances of functionality ID X during the defined durations. In this case, the UE 302 may follow tracking window based on the network (the gNB 304) guided duration. The UE 302 may inform the gNB 304 by an indication when a tracking window ID begins and ends to allow the gNB 304 to synchronize its side.

In some example embodiments, in a case that the tracking windows may be fully guided by the gNB 304 provided time duration (and not on execution condition), the signaling (344, 346, 348) may be omitted.

In some example embodiments, the gNB 304 may track the model performance by considering one or more key performance indicators (KPIs). The gNB 304 may determine the performance of the given functionality considering one or more KPIs. The one or more KPIs may comprise an accuracy, a data throughput, a block error rate (BLER), a number of retransmissions, a number of hybrid automatic repeat requests (HARQs), a number of beam failures (BF), or a number of radio link failures (RLF). The one or more KPIs may be for each of the model-LCM-tracking windows during the time duration m*T (or T1+T2+ . . . Tm).

In some example embodiments, when all tacking windows are used up (352), the gNB 304 may summarize a history of determined KPIs and arrange or aggregate it in different ways. For example, the gNB 304 may arrange or aggregate the history KPIs based on functionality ID and/or any other information available about the UE 302 or from the functionality meta-information, e.g., vendor ID, UE model ID, UE capabilities, etc. For another example, the gNB 304 may arrange or aggregate the history KPIs in LCM-tracking windows, minimal length of LCM-Tracking windows or other fixed time intervals. In a further example, the gNB 304 may mark or enrich the history KPIs with additional information, e.g., load in the network, time of day, position of the UE 302, etc. In yet another example, the gNB 304 may collect and update the statistical measures of the KPIs, mean, deviation, distributions, etc. In a yet further example, the update can be done to a UE-vendor pair in the AI/ML model info or as a UE vendor specific information in the AI/ML model info for later retrieval.

In some example embodiments, if the gNB 304 wishes to perform additional measurements on the UE 302, a follow up request may be provided to the UE 302 with a different configuration of tracking window ID durations/conditions. For example, the gNB 304 may be interested in a specific tracking duration earlier and may choose to emphasize the UE 302 to use the AI/ML model connected to it. This is reflected in dashed block 356, which shows initialization of another sequence of tracking. The gNB 304 may transmit (360) a configuration request (362) to the UE 302. The UE 302 may receive (358) the configuration request (362). The UE 302 may transmit (364) a configuration response (368) to the gNB 304. The gNB 304 may receive (366) the configuration response (368) from the UE 302.

In some example embodiments, if the gNB 304 is convinced based on the summary of the determined KPIs and the gNB 304 considers that the UE 302 may not perform an AI/ML model switching in a given tracking window, it may set a configuration with a preferred window configuration request that contains the observed and confirmed tracking window IDs that the gNB 304 approves. In the case of the execution configuration, the gNB 304 may indicate the tracking window ID along with the preferred tracking window duration and sub-tracking window IDs.

In some example embodiments, the gNB 304 may compare the determined KPIs of model-LCM-tracking windows. As an example, the comparison may be based on the best, the worse, or an average considerations or KPI distribution methods to observe outliers to changes of KPIs over time. As another example, the comparison may be based on some other metrics (delta variation over time, etc.) which may be derived based on determined KPIs.

In some example embodiments, when the determined KPIs across multiple model-LCM-tracking windows are within a certain level of performance variations (e.g., if the accuracy is used as the KPI and each window is within X % (where X is a value, such as X=5, 10, etc.) variation), the KPIs do not vary significantly from each other. Thus, the gNB 304 may not need to initiate any additional steps and continue with the above-mentioned steps for future use of the functionality.

In some example embodiments, When the determined KPIs across multiple model-LCM-tracking windows are not within a certain level of performance variations (e.g., if accuracy is used as the KPI and some windows are not within X % variation), The KPIs do vary significantly from each other. The gNB 304 may additionally derive the best or worse model-LCM-tracking windows based on the determined KPIs.

In some example embodiments, the performance level may be either an absolute value or a relative value. The absolute value means that a KPI value is compared to an absolute threshold. The relative value means that a KPI variation (with respect to another KPI value, such as a previously measured KPI value for an AI/ML functionality) is compared to a relative threshold (this means the performance improves or worsens by X %). Also, the KPI variation can be above a threshold while being indicative of either a performance improvement or a performance degradation depending on which KPI is measured. For instance, a data throughput increasing by 10% is indicative of an improved performance, whereas a BER increasing by 10% is indicative of a degraded performance.

This is reflected in dashed block 370, which shows a detailed process of configuring UE with a preferred tracking window. The gNB 304 may transmit (374) a configuration request (376) to configuring the preferred tracking window to the UE 302. The UE 302 may receive (372) the configuration request (376) from the gNB 302. The UE 302 may transmit (378) a configuration response (382) to the gNB 304. The gNB 304 may receive (380) the configuration response (382) from the UE 302.

In some example embodiments, the UE 302 may be allowed to do only one operation associated with the model-ID-based LCM (only one model switch) within the model-LCM-tracking time duration (T or T1/T2 . . . /Tm). In some example embodiments, when performance variation is identified for one or more model-LCM-tracking windows, the gNB 304 may indicate the preferred (or not preferred) model-LCM-tracking window in order to continue with the associated functionality.

In some example embodiments, as the UE 302 may be aware of the exact LCM change during the indicated model-LCM-tracking window, the UE 302 shall correct the LCM step performed in the model-LCM-tracking window (in case of performance degradation is observed and the network indicated as not preferred model-LCM-tracking window) or keep the LCM step performed in the model-LCM-tracking window (in case of performance gain is observed and network indicated as the preferred model-LCM-tracking window).

In some example embodiments, if the AI/ML model is not anymore used (due to change in use case, or not being in use, invalid, etc), the UE 302 will trigger an indication of inactive signalling to the gNB 304. This will tell the gNB 304 to stop the model-LCM-tracking window for that AI/ML model. In some example embodiments, if it is a test setup case, then the violations (KPI is not within certain level of performance variations) of the KPIs across multiple model-LCM-tracking windows is collected by the TE, and if the number of violated intervals is above a threshold (such as xx %, where xx ranges from 0 to 100), then the test may be considered to be failed.

In some example embodiments, the UE 302 may suspend any management operation associated with the plurality of AI/ML models during the at least one time window. As an example, the UE 302 may suspend activating, deactivating, adjusting an AI/ML model.

In some example embodiments, the gNB 304 may transmit (382) an update tracking window data request (386) for a given functionality ID (such as functionality ID X) to the core network device 306. The core network device 306 may receive (384) the update tracking window data request (386) from the gNB 304. The core network device 306 may transmit (390) an update tracking window data response (392) to the gNB 304. The gNB 304 may receive (388) the update tracking window data response (392) from the core network device 306.

In some example embodiments, the UE 302 may transmit (391) an update tracking window data request (393) for a given functionality ID and an AI/ML model (such as functionality ID X and AI/ML model ID X) to the vendor database 308. The vendor database 308 may receive the update tracking window data request (393) from the UE 302. The vendor database 308 may transmit (395) an update tracking window data response (396) for the given functionality ID and the AI/ML model to the UE 302. The UE 302 may receive (394) the update tracking window data response (396).

In functionality-based LCM, AI/ML models may not be identified at the network, and the UE may perform model-level LCM. Therefore, by implementing FIG. 3, it can allow the awareness and/or interaction that the network should have about model-level LCM, and thus the network does not have to know exactly about the AI/ML model the UE is using but still have control if the performance is not up to the mark. It can further allow the network and the UE to store the summary of the KPIs performed to test the AI/ML model during functionality based LCM switching, and thus allow the network to configure the UE appropriately for a given functionality ID.

It is understood that while the above description is related to network-side operation, it is understood that it may be performed by the UE. In this case, some additional steps might imply that the UE signals to the network a change or request in model-LCM tracking window. There may be also the possibility that the network and the UE are operating in a digital twin fashion where both entities (UE and network) are performing similar steps in model-LCM tracking window operation.

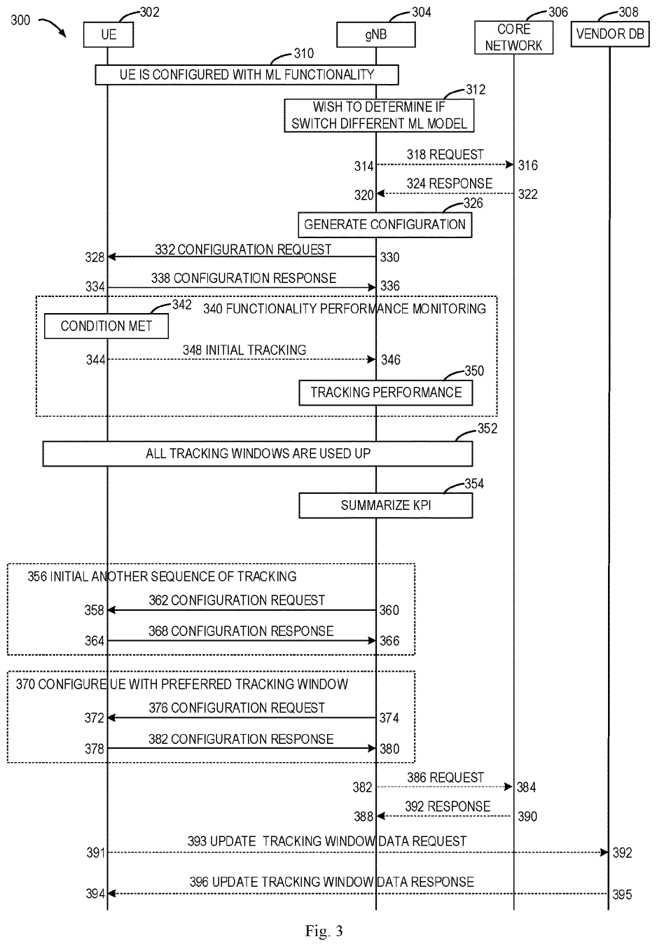

Reference is made to FIG. 4, which illustrates an example flowchart 400 of a method implemented at a terminal device in accordance with some example embodiments of the present disclosure. Reference will be made in combination with FIG. 1A.

At 402, the terminal device 102 receives first information for configuring at least one time window for monitoring a performance of an AI/ML model functionality from a network device 104. In some example embodiments, the first information may comprise an identifier of the AI/ML model functionality. The first information may further comprise an identifier of a time window among the at least one time window. The first information may further comprise a duration of the time window. The first information may further comprise a criterion associated with the time window for causing the terminal device to perform a model switching between the plurality of AI/ML models.

At 404, the terminal device 102 receives second information from the network device 104. In some example embodiments, the second information may be indicative of a first time window among the at least one time window during which the performance of the AI/ML model functionality is above a performance level. Otherwise the second information may be indicative of a second time window among the at least one time window during which the performance of the AI/ML model functionality is below the performance level.

At 406, based on the second information, the terminal device 102 performs a management operation associated with a plurality of AI/ML models configured to carry out the AI/ML model functionality. In some example embodiments, the management operation may comprise activating an AI/ML model out of the plurality of AI/ML models. The management operation may further comprise deactivating an AI/ML model out of the plurality of AI/ML models. The management operation may further comprise adjusting an AI/ML model out of the plurality of AI/ML models. The management operation may further comprise switching between the plurality of AI/ML models and/or selecting between the plurality of AI/ML models.

In some example embodiments, based on determining that the criterion is met, the terminal device 102 may determine a start point, and at least one of an end point of the time window or a duration of the time window. The terminal device 102 may transmit third information to the network device 104. The third information is indicative of the start point, and of at least one of the end point of the time window and the duration of the time window.

In some example embodiments, if the second information is indicative of the first time window, the terminal device 102 may perform the management operation by identifying a first AI/ML model out of the plurality of AI/ML models that was used during the first time window as being a suitable AI/ML model for carrying out the AI/ML model functionality.

In some example embodiments, if the second information is indicative of the second time window, terminal device 102 may perform the management operation by identifying a second AI/ML model out of the plurality of AI/ML models that is used during the second time window as not being a suitable AI/ML model for carrying out the AI/ML model functionality.

In some example embodiments, the terminal device 102 may suspend any management operation associated with the plurality of AI/ML models during the at least one time window. In some example embodiments, if the terminal device 102 determines that more than one AI/ML model among the plurality of AI/ML models is used in a time window among the at least one time window, the terminal device 102 may determine more than one sub-time window corresponding to the more than one AI/ML model used in the time window, respectively. The terminal device 102 may transmit fourth information to the network device 104. The fourth information is indicative of the more than one sub-time window.

In some example embodiments, the at least one time window comprises a plurality of time windows, and the plurality of AI/ML models are used in the plurality of time windows, respectively.

In some example embodiments, if the terminal device 102 determines that an AI/ML model among the plurality of AI/ML models shall no longer be used, the terminal device 102 may transmit fifth information to the network device 104. The fifth information is indicative that the AI/ML model is no longer used.

In some example embodiments, the at least one time window may comprise a plurality of time windows, and the plurality of time windows have a same duration, or at least two time windows of the plurality of time windows have different durations.

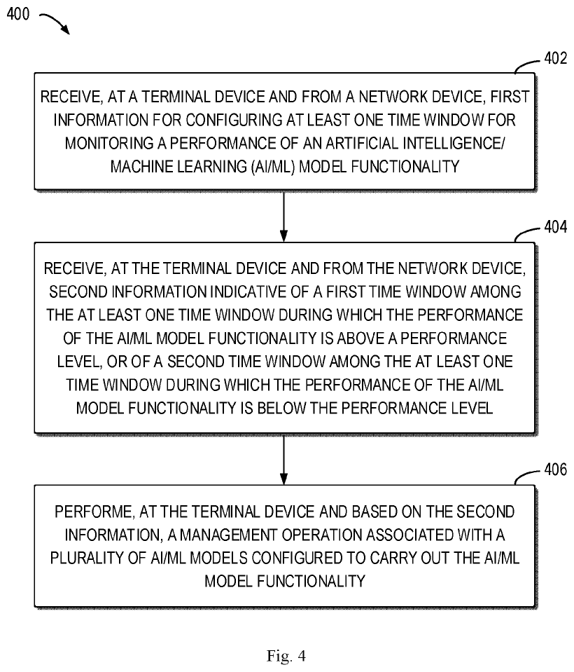

Reference is made to FIG. 5, which illustrates an example flowchart 500 of a method implemented at a network device in accordance with some example embodiments of the present disclosure. Reference will be made in combination with FIG. 1A.

At 502, the network device 104 transmits first information for configuring at least one time window for monitoring a performance of an AI/ML model functionality to the terminal device 102. In some example embodiments, the first information may comprise an identifier of the AI/ML model functionality. The first information may further comprise an identifier of a time window among the at least one time window. The first information may further comprise a duration of the time window. The first information may further comprise a criterion associated with the time window for causing the terminal device to perform a model switching between the plurality of AI/ML models.

At 504, the network device 104 determines a first time window or a second time window. The first time window is a time window among the at least one time window during which the performance of the AI/ML model functionality is above a performance level. The first time window is a time window among the at least one time window during which the performance of the AI/ML model functionality is below the performance level.

At 506, the network device 104 transmits second information indicative of the first time window or of the second time window to the terminal device 102. In some example embodiments, the second information may be indicative of a first time window among the at least one time window during which the performance of the AI/ML model functionality is above a performance level. Otherwise the second information may be indicative of a second time window among the at least one time window during which the performance of the AI/ML model functionality is below the performance level.

In some example embodiments, the second information may be used by the terminal device 102 to perform a management operation associated with a plurality of AI/ML models configured to carry out the AI/ML model functionality. In some example embodiments, the management operation may comprise activating an AI/ML model out of the plurality of AI/ML models. The management operation may further comprise deactivating an AI/ML model out of the plurality of AI/ML models. The management operation may further comprise adjusting an AI/ML model out of the plurality of AI/ML models. The management operation may further comprise switching between the plurality of AI/ML models and/or selecting between the plurality of AI/ML models.

In some example embodiments, in the event that the first information comprises the criterion, the network device 104 may receive third indication from the terminal device 102. The third information may be indicative of a start point, and of at least one of an end point of the time window and the duration of the time window.

In some example embodiments, the network device 104 may receive fourth information from the terminal device 102. The fourth information may be indicative of more than one sub-time window in a time window among the at least one time window, wherein the more than one sub-time window corresponds to more than one AI/ML model which is used by the terminal device in the time window.

In some example embodiments, the at least one time window may comprise a plurality of time windows. The network device 104 may determine at least one of the first time window or the second time window by: determining, for the plurality of time windows, a plurality of KPI values of a KPI associated with the AI/ML model functionality; based on comparing the plurality of KPI values, determining that the performance in the first time window is above the performance level; or based on comparing the plurality of KPI values, determining that the performance in the second time window is below the performance level.

In some example embodiments, the KPI may comprise an accuracy, a data throughput, a block error rate (BLER), a number of retransmissions, a number of hybrid automatic repeat requests (HARQs), a number of beam failures (BF), or a number of radio link failures (RLF) associated with the AI/ML model functionality.

In some example embodiments, the network device 104 may receive fifth information from the terminal device 102. The fifth information is indicative that an AI/ML model among the plurality of AI/ML models is no longer used. In some example embodiments, the at least one time window may comprise a plurality of time windows, and the plurality of time windows have a same duration, or at least two time windows of the plurality of time windows have different durations.

In some example embodiments, the network device 104 may determine that the performance of the AI/ML model functionality is above the performance level by determining that a performance variation associated with the first time window is below a predetermined variation level. In some example embodiments, the network device 104 may determine that the performance of the AI/ML model functionality is below the performance level by determining that a performance variation associated with the second time window is above a predetermined variation level.

In some example embodiments, the at least one time window comprises a plurality of time windows, and the plurality of AI/ML models are used in the plurality of time windows, respectively.

By implementing the methods 400 and 500, the example embodiments for AI/ML model functionality monitoring can allow the awareness and/or interaction that the network should have about model-level LCM, and thus the network does not have to know exactly about the AI/ML model the UE is using but still have control if the performance is not up to the mark. It can further allow the network and the UE to store the summary of the KPIs performed to test the AI/ML model during functionality based LCM switching, and thus allow the network to configure the UE appropriately for a given functionality ID.

In some example embodiments, an apparatus capable of performing the method 400 may comprise means for performing the respective steps of the method 400. The means may be implemented in any suitable form. For example, the means may be implemented in a circuitry or software module.

In some example embodiments, the apparatus may comprise means for receiving, from a network device, first information for configuring at least one time window for monitoring a performance of an AI/ML model functionality; means for receiving, from the network device, second information indicative of a first time window among the at least one time window during which the performance of the AI/ML model functionality is above a performance level, or of a second time window among the at least one time window during which the performance of the AI/ML model functionality is below the performance level; and means for performing, based on the second information, a management operation associated with a plurality of AI/ML models configured to carry out the AI/ML model functionality.

In some example embodiments, the management operation may comprise at least one of the following: activating an AI/ML model out of the plurality of AI/ML models; deactivating an AI/ML model out of the plurality of AI/ML models; or adjusting an AI/ML model out of the plurality of AI/ML models.

In some example embodiments, the first information may comprise at least one of the following: an identifier of the AI/ML model functionality; an identifier of a time window among the at least one time window; a duration of the time window; or a criterion associated with the time window for causing the terminal device to perform a model switching between the plurality of AI/ML models.

In some example embodiments, the apparatus may further comprise means for based on determining that the criterion is met, determining a start point, and at least one of an end point of the time window or a duration of the time window; and means for transmitting, to the network device, third information indicative of the start point, and of at least one of the end point of the time window and the duration of the time window.

In some example embodiments, the second information may comprise at least one of the following: an identifier of a time window among the at least one time window; an indication as to whether the time window characterizes as the first time window or as the second time window; or a performance measure of the AI/ML model functionality during the time window.

In some example embodiments, the means for performing the management operation may further comprise means for based on receiving the second information indicative of the first time window, identifying a first AI/ML model out of the plurality of AI/ML models that was used during the first time window as being a suitable AI/ML model for carrying out the AI/ML model functionality.

In some example embodiments, the means for performing the management operation may further comprise means for based on receiving the second information indicative of the second time window, identifying a second AI/ML model out of the plurality of AI/ML models that is used during the second time window as not being a suitable AI/ML model for carrying out the AI/ML model functionality.

In some example embodiments, the apparatus may further comprise means for suspending any management operation associated with the plurality of AI/ML models during the at least one time window.

In some example embodiments, the apparatus may further comprise means for based on determining that more than one AI/ML model among the plurality of AI/ML models is used in a time window among the at least one time window, determining more than one sub-time window corresponding to the more than one AI/ML model used in the time window, respectively; and means for transmitting, to the network device, fourth information indicative of the more than one sub-time window.

In some example embodiments, the at least one time window may comprise a plurality of time windows, and the plurality of AI/ML models are used in the plurality of time windows, respectively.

In some embodiments, the apparatus may further comprise means for performing other steps in some embodiments of the method 400. In some embodiments, the means comprises at least one processor and at least one memory including computer program code, the at least one memory and computer program code configured to, with the at least one processor, cause the performance of the apparatus.

In some example embodiments, an apparatus capable of performing the method 500 may comprise means for performing the respective steps of the method 500. The means may be implemented in any suitable form. For example, the means may be implemented in a circuitry or software module.

In some example embodiments, the apparatus may comprise means for transmitting, to a terminal device, first information for configuring at least one time window for monitoring a performance of an AI/ML model functionality; means for determining a first time window among the at least one time window during which the performance of the AI/ML model functionality is above a performance level, or a second time window among the at least one time window during which the performance of the AI/ML model functionality is below the performance level; and means for transmitting, to the terminal device, second information indicative of the first time window or of the second time window.

In some example embodiments, the first information may comprise at least one of the following: an identifier of the AI/ML model functionality; an identifier of a time window among the at least one time window; a duration of the time window; or a criterion associated with the time window for causing the terminal device to perform a model switching between the plurality of AI/ML models.

In some example embodiments, the second information is used by the terminal device to perform a management operation associated with a plurality of AI/ML models configured to carry out the AI/ML model functionality.

In some example embodiments, the management operation may comprise at least one of the following: activating an AI/ML model out of the plurality of AI/ML models; deactivating an AI/ML model out of the plurality of AI/ML models; or adjusting an AI/ML model out of the plurality of AI/ML models.

In some example embodiments, the apparatus may further comprise means for in the event that the first information comprises the criterion, receiving, from the terminal device, third indication information indicative of a start point, and of at least one of an end point of the time window and the duration of the time window.

In some example embodiments, the apparatus may further comprise means for receiving, from the terminal device, fourth information indicative of more than one sub-time window in a time window among the at least one time window, wherein the more than one sub-time window corresponds to more than one AI/ML model which is used by the terminal device in the time window.

In some example embodiments, the at least one time window may comprise a plurality of time windows, and the means for determining at least one of the first time window or the second time window may comprise means for determining, for the plurality of time windows, a plurality of key performance indicator (KPI) values of a KPI associated with the AI/ML model functionality; means for based on comparing the plurality of KPI values, determining that the performance in the first time window is above the performance level; and means for based on comparing the plurality of KPI values, determining that the performance in the second time window is below the performance level.

In some example embodiments, the KPI may comprises at least one of the following: an accuracy, a data throughput, a block error rate (BLER), a number of retransmissions, a number of hybrid automatic repeat requests (HARQs), a number of beam failures (BF), or a number of radio link failures (RLF) associated with the AI/ML model functionality.

In some embodiments, the apparatus may further comprise means for performing other steps in some embodiments of the method 500. In some embodiments, the means comprises at least one processor and at least one memory including computer program code, the at least one memory and computer program code configured to, with the at least one processor, cause the performance of the apparatus.

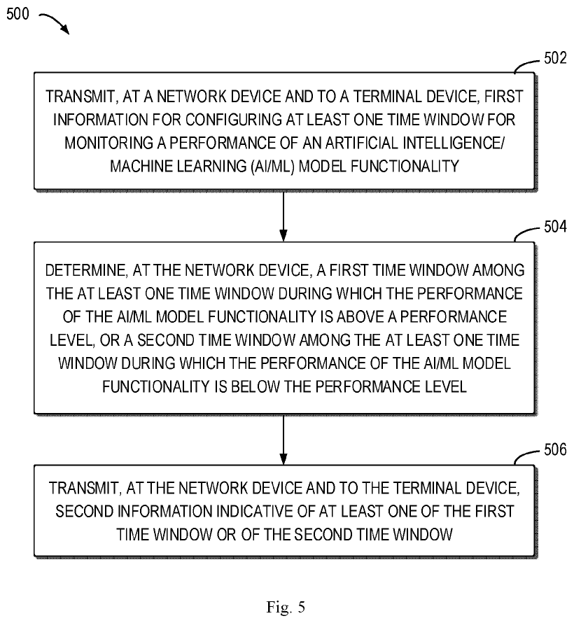

Reference is made to FIG. 6, which illustrates an example simplified block diagram of a device that is suitable for implementing embodiments of the present disclosure. The device 600 may be provided to implement the communication device, for example the terminal device 102 as shown in FIG. 1A. As shown, the device 600 includes one or more processors 610, one or more memories 620 may couple to the processor 610, and one or more communication modules 640 may couple to the processor 610.

The communication module 640 is for bidirectional communications. The communication module 640 has at least one antenna to facilitate communication. The communication interface may represent any interface that is necessary for communication with other network elements, for example the communication interface may be wireless or wireline to other network elements, or software based interface for communication.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a read only memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program so that the device 600 may perform any process of the disclosure as discussed with reference to FIG. 2 to FIG. 5. The embodiments of the present disclosure may also be implemented by hardware or by a combination of software and hardware.

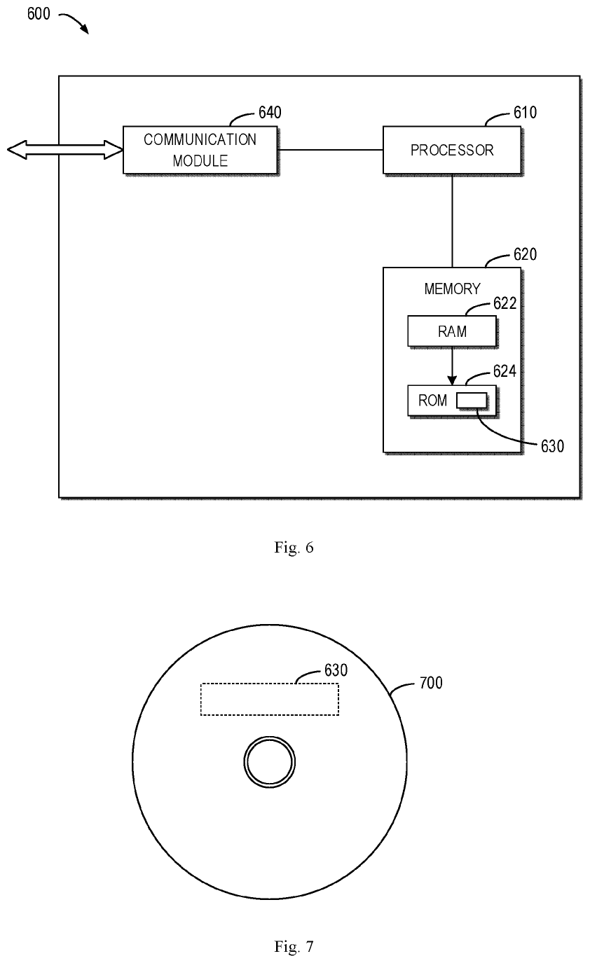

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 400 or 500 as described above with reference to FIG. 4 or FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-21. (canceled)

22. A terminal device comprising:
at least one processor; and
at least one memory storing instructions that, when executed by the at least one processor, cause the terminal device at least to:
receive, from a network device, first information for configuring at least one time window for monitoring a performance of an artificial intelligence/machine learning (AI/ML) model functionality;
receive, from the network device, second information indicative of a first time window among the at least one time window during which the performance of the AI/ML model functionality is above a performance level, or of a second time window among the at least one time window during which the performance of the AI/ML model functionality is below the performance level; and
perform, based on the second information, a management operation associated with a plurality of AI/ML models configured to carry out the AI/ML model functionality.

23. The terminal device of claim 22, wherein the management operation comprises at least one of the following:
activating an AI/ML model out of the plurality of AI/ML models;
deactivating an AI/ML model out of the plurality of AI/ML models; or
adjusting an AI/ML model out of the plurality of AI/ML models.

24. The terminal device of claim 22, wherein the first information comprises at least one of the following:
an identifier of the AI/ML model functionality;
an identifier of a time window among the at least one time window;
a duration of the time window; or
a criterion associated with the time window for causing the terminal device to perform a model switching between the plurality of AI/ML models.

25. The terminal device of claim 24, wherein the terminal device is further caused to:
based on determining that the criterion is met, determine a start point, and at least one of an end point of the time window or a duration of the time window; and
transmit, to the network device, third information indicative of the start point, and of at least one of the end point of the time window or the duration of the time window.

26. The terminal device of claim 22, wherein the second information comprises at least one of the following:
an identifier of a time window among the at least one time window;
an indication as to whether the time window characterizes as the first time window or as the second time window; or
a performance measure of the AI/ML model functionality during the time window.

27. The terminal device of claim 22, wherein the terminal device is caused to perform the management operation by:
based on receiving the second information indicative of the first time window, identifying a first AI/ML model out of the plurality of AI/ML models that was used during the first time window as being a suitable AI/ML model for carrying out the AI/ML model functionality.

28. The terminal device of claim 22, wherein the terminal device is caused to perform the management operation by:
based on receiving the second information indicative of the second time window, identifying a second AI/ML model out of the plurality of AI/ML models that is used during the second time window as not being a suitable AI/ML model for carrying out the AI/ML model functionality.

29. The terminal device of claim 22, wherein the terminal device is further caused to suspend any management operation associated with the plurality of AI/ML models during the at least one time window.

30. The terminal device of claim 22, wherein terminal device is further caused to:
based on determining that more than one AI/ML model among the plurality of AI/ML models is used in a time window among the at least one time window, determine more than one sub-time window corresponding to the more than one AI/ML model used in the time window, respectively; and
transmit, to the network device, fourth information indicative of the more than one sub-time window.

31. The terminal device of claim 22, wherein the at least one time window comprises a plurality of time windows, and wherein the plurality of AI/ML models are used in the plurality of time windows, respectively.

32. A network device comprising:
at least one processor; and
at least one memory storing instructions that, when executed by the at least one processor, cause the network device at least to:
transmit, to a terminal device, first information for configuring at least one time window for monitoring a performance of an artificial intelligence/machine learning (AI/ML) model functionality;
determine a first time window among the at least one time window during which the performance of the AI/ML model functionality is above a performance level, or a second time window among the at least one time window during which the performance of the AI/ML model functionality is below the performance level; and
transmit, to the terminal device, second information indicative of the first time window or of the second time window.

33. The network device of claim 32, wherein the second information is used by the terminal device to perform a management operation associated with a plurality of AI/ML models configured to carry out the AI/ML model functionality,
and wherein the management operation comprises at least one of the following:
activating an AI/ML model out of the plurality of AI/ML models;
deactivating an AI/ML model out of the plurality of AI/ML models; or
adjusting an AI/ML model out of the plurality of AI/ML models.

34. The network device of claim 32, wherein the first information comprises at least one of the following:
an identifier of the AI/ML model functionality;
an identifier of a time window among the at least one time window;
a duration of the time window; or
a criterion associated with the time window for causing the terminal device to perform a model switching between the plurality of AI/ML models.

35. The network device of claim 34, wherein the network device is further caused to:
in the event that the first information comprises the criterion, receive, from the terminal device, third indication information indicative of a start point, and of at least one of an end point of the time window or the duration of the time window.

36. The network device of claim 32, wherein the second information comprises at least one of the following:
an identifier of a time window among the at least one time window;
an indication as to whether the time window characterizes as the first time window or as the second time window; or
a performance measure of the AI/ML model functionality during the time window.

37. The network device of claim 32, wherein network device is further caused to:
receive, from the terminal device, fourth information indicative of more than one sub-time window in a time window among the at least one time window, wherein the more than one sub-time window corresponds to more than one AI/ML model which is used by the terminal device in the time window.

38. The network device of claim 32, wherein the at least one time window comprises a plurality of time windows, and the network device is caused to determine at least one of the first time window or the second time window by:
determining, for the plurality of time windows, a plurality of key performance indicator (KPI) values of a KPI associated with the AI/ML model functionality;
based on comparing the plurality of KPI values, determining that the performance in the first time window is above the performance level; or
based on comparing the plurality of KPI values, determining that the performance in the second time window is below the performance level.

39. The network device of claim 38, wherein the KPI comprises at least one of the following:
an accuracy, a data throughput, a block error rate (BLER), a number of retransmissions, a number of hybrid automatic repeat requests (HARQs), a number of beam failures (BF), or a number of radio link failures (RLF) associated with the AI/ML model functionality.

40. A method comprising:
receiving, at a terminal device and from a network device, first information for configuring at least one time window for monitoring a performance of an artificial intelligence/machine learning (AI/ML) model functionality;
receiving, at the terminal device and from the network device, second information indicative of a first time window among the at least one time window during which the performance of the AI/ML model functionality is above a performance level, or of a second time window among the at least one time window during which the performance of the AI/ML model functionality is below the performance level; and
performing, at the terminal device and based on the second information, a management operation associated with a plurality of AI/ML models configured to carry out the AI/ML model functionality.
